(19) United States
(12) Patent Application Publication
(10) Pub. No.: US 2015/0079575 A1
(43) Pub. Date: Mar. 19, 2015

(54) Method and System for Facilitating Discussion of Issues Pertaining to Subject Matter Taught By A Course

(71) Applicant: APOLLO GROUP, INC., Phoenix, AZ (US)

(72) Inventor: Collin Couch, Gilbert, AZ (US)

(73) Assignee: APOLLO GROUP, INC., Phoenix, AZ (US)

(21) Appl. No.: 14/030,359

(22) Filed: Sep. 18, 2013

(51) Int. Cl. G09B 5/02

(52) U.S. Cl. CPC G09B 5/02
USPC 434/350; 434/362

(57) ABSTRACT

A method and system are provided for finding and presenting content that is relevant to the subject matter taught by a course, and for facilitating discussion of such content in a discussion forum that is outside of a classroom. Because the content is relevant to the subject matter taught by the course, and because the content is used to initiate discussion, it is likely that the ensuing discussion will focus on issues that pertain to the subject matter taught by the course. Also, because the discussion is conducted in a non-classroom discussion forum, students may feel more comfortable expressing their thoughts and opinions; hence, students are more likely to participate in the discussion and are more likely to be engaged by it. Consequently, the method and system are likely to foster focused and constructive discussion of issues pertaining to the subject matter taught by a course.

### FIELD OF THE INVENTION

The present invention relates generally to educational systems and more particularly to a method and system for facilitating discussion of issues pertaining to subject matter taught by a course.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In education, an effective way to foster learning is to engage students in the discussion of issues that pertain to the subject matter taught by an educational course. During such discussions, students are given the opportunity to apply the concepts that they have learned from the course to facts, and to formulate their own thoughts and conclusions. Thus, these discussions provide beneficial opportunities for the students to reinforce what they have learned, and to potentially come up with new ideas.

Faculty members may try to engage students in such discussions by posing hypothetical facts that are designed to stimulate discussion of certain issues. However, because these facts are contrived and not based on real current events or issues, they may not capture the interest of the students. Also, because the discussion is conducted in a classroom type setting with a potentially large number of students present, some students may not feel comfortable expressing their thoughts. In addition, some classroom discussions may be dominated but just a small number of students. For these and other reasons, classroom setting discussions often do not fully engage a large percentage of the students.

If so inclined, students may discuss issues pertaining to the subject matter taught by a course outside of a classroom setting, such as in person or in an online discussion forum. Unfortunately, the discussions in such settings tend to be unfocused and unguided. As a result, they often deteriorate quickly into nothing more than social chats that have little to do with the subject matter taught by a course.

### BRIEF DESCRIPTION OF THE DRAWINGS

FIG. 1 is a block diagram of a system in which one embodiment of the present invention may be implemented.

FIG. 2 is an operational flow diagram that illustrates how the system of FIG. 1 may operate, in accordance with one embodiment of the present invention.

FIG. 3 is a block diagram of a sample computer system that may be used to implement at least a portion of the present invention.

### DETAILED DESCRIPTION OF EMBODIMENT(S)

### Overview

In one embodiment, to foster constructive and focused discussion of issues that pertain to the subject matter taught by an educational course, a method and system are provided for finding and presenting content that is relevant to the subject matter taught by a course, and facilitating the discussion of such content in a discussion forum that is outside of a classroom. Because the content is relevant to the subject matter taught by the course, and because the content is used to initiate discussion, it is likely that the ensuing discussion will focus on issues that pertain to the subject matter taught by the course. Also, because the discussion is conducted in a non-classroom discussion forum, students may feel more comfortable expressing their thoughts and opinions; hence, students are more likely to participate in the discussion and are more likely to be engaged by it. Furthermore, the content that is found and presented may be current content that reflects current events and issues; as a result, the students are likely to be interested in the issues raised by the content. Consequently, the method and system provide a mechanism that is likely to foster focused and constructive discussion of issues pertaining to the subject matter taught by a course.

In one embodiment, the method and system have a “find and present” aspect and a “discussion facilitation” aspect. With the find and present aspect, content relevant to the subject matter taught by an educational course is found and presented to a student. With the discussion facilitation aspect, the student is allowed to post a set of content or a reference to a set of content to a discussion forum and conduct a discussion of the content with one or more other students.

In one embodiment, the find and present aspect may be implemented as follows. Initially, a determination is made that a particular student is associated with a particular educational course. The particular course may, for example, be one that the particular student is currently taking. A determination is then made as to what subject matter is taught by the particular course. A search is then caused to be performed to find one or more sets of content that pertain to at least a portion of the subject matter taught by the particular course. In one embodiment, the search is an online search (e.g. an Internet search) that is performed on online resources, such as news websites, blog websites, discussion forum websites, or any other websites that are available online. The content that is found may include news articles, publications, information posted on a discussion forum or blog, etc., that reflect current events and issues. As part of the search criteria, personal aspects of the particular student may be included. For example, the student may be interested in certain topics (e.g. sports, cooking, etc.), certain people (e.g. athletes, actors, business professionals, etc.), certain locations (e.g. cities, states, national parks, etc.), certain business entities (e.g. companies, sports teams, etc.), certain educational institutions (e.g. high schools, colleges/universities, etc.), etc. These personal aspects may be taken into account in filtering or ranking the content that is found by the search. Thus, not only are the sets of content found by the search relevant to the subject matter taught by the particular course, they may also be tailored to the personal preferences of the particular student. Thus, they are likely to be of interest to the particular student. After the content is found, a set of information is caused to be presented to the particular student that includes the content or one or more references (e.g. one or more links) to the content. The particular student may then review the content and determine whether he/she wishes to discuss the content with other students. As part of reviewing a set of content, the particular student may provide a rating for the set of content.

If the particular student wishes to discuss a set of content with other students, the particular student may invoke the discussion facilitation aspect of the method and system. This aspect allows the particular student to post a set of content or a reference to a set of content to a discussion forum. In one embodiment, the discussion forum is an online discussion forum that is accessible to a plurality of students. The particular student may provide some comments on the posted content to start the discussion. Within the discussion forum, other students are able to review the posted content and the comments provided by the particular student. The other students may also provide comments of their own. All such comments are posted to the discussion forum and may be viewed by students interested in the discussion of the posted content; thus, discussion of the posted content is facilitated. Because the posted content pertains to the subject matter taught by the particular course, the discussion of the posted content will likely be focused on issues that pertain to the subject matter taught by the course. Thus, the discussion is likely to be constructive and focused.

### Sample System

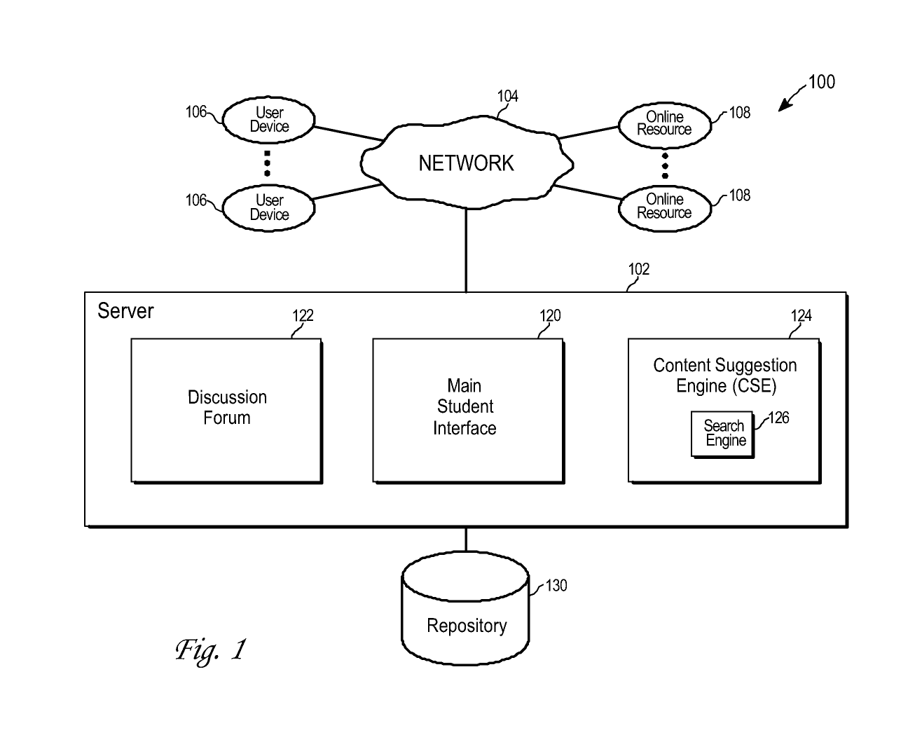

With reference to FIG. 1, there is shown a functional block diagram of a system 100 in which one embodiment of the present invention may be implemented. As shown, system 100 comprises a server 102 coupled to a repository 130 and a network 104, which in turn is coupled to one or more user devices 106 and one or more online resources 108. For purposes of the present invention, the network 104 may be any type of network, such as a local area network (LAN), a wide area network (WAN) (e.g. the Internet), or any other type of network or any combination of networks that enables communication to be effected between the server 102 and one or more other devices or systems.

The user devices 106 may take on any of various forms, including but not limited to desktop computers, laptop computers, tablet computers, smartphones, mobile devices, etc. The user devices 106 may be used by users (e.g. students, administrators, etc.) to access resources and functionalities provided by the server 102. The user devices 106 may execute a web browser or one or more other applications. The web browser or other application may implement a user interface and/or an application programming interface (API) to enable a user to use a user device 106 to interact with the server 102. Various users may use a user device 106 to interact with the server 102 for various purposes. For example, a student may use a user device 106 to interact with the server 102 to study the course materials of a particular course, to take a test associated with a particular course, etc. A student may also use a user device 106 to review content that has been found that pertains to the subject matter taught by a course. Furthermore, a student may use a user device 106 to access a discussion forum provided by the server 102. These and other users may use the user devices 106 to interact with the server 102 for these and other purposes. All such interactions are within the scope of the present invention.

The online resources 108 represent the entities that store/provide content that can be searched and accessed. For purposes of the present invention, an online resource 108 may be any type of entity that provides any type of content. For example, an online resource 108 may be a website (e.g. news website, merchant website, blog website, discussion forum website, etc.), a web server, a content repository, a content server, a storage server, etc. The content available from an online resource 108 may include, for example, news articles, books or other publications (e.g. magazines, articles, periodicals, etc.), information posted on blogs, information posted on discussion forums, videos, audio recordings, multimedia content, etc. The content found on the online resources 108 may (and likely) pertain to current events and current issues. In one embodiment, it is the online resources 108 that are searched or “scraped” to find content that pertains to subject matter taught by a course.

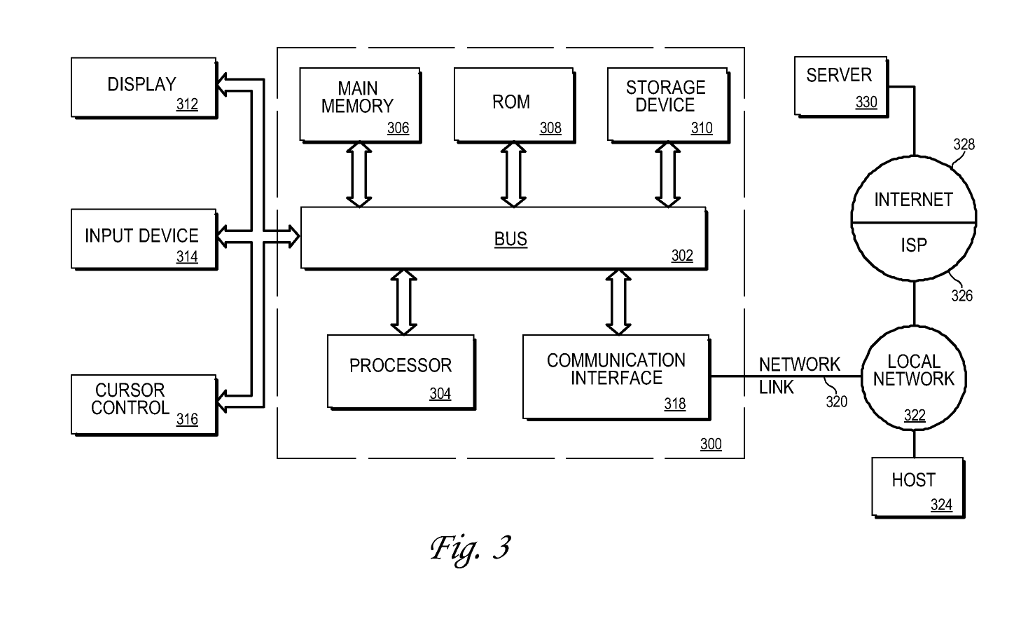

As shown in FIG. 1, the server 102, in one embodiment, may comprise a main student interface component 120, a discussion forum component 122, and a content suggestion engine (CSE) component 124. It should be noted that these are just some of the components that may be implemented on the server 102. Other components, not shown, may be implemented as well if so desired. In one embodiment, the server 102 may be implemented as one or more computer systems, such as the sample computer system shown in FIG. 3, which will be described in a later section. If the server 102 is implemented as a single computer system, then all of the components 120, 122, 124 may be implemented on that computer system. If the server 102 is implemented as multiple computer systems, then the various components 120, 122, 124 may be implemented on various computer systems in various combinations. For example, each of the components 120, 122, 124 may be implemented on a separate computer system, or components 120 and 124 may be implemented on one computer system while component 122 is implemented on another, or components 120 and 122 may be implemented on one computer system while component 124 is implemented on another, or some other combination may be used. For purposes of the present invention, the server 102 may be implemented using any number of computer systems, and the components 120, 122, 124 of the server 102 may be implemented on any of the computer systems in any desired combination.

Also, FIG. 1 shows components 120, 122, 124 as being separate components. This is not required. If so desired, all of the components 120, 122, 124 may be implemented as one integrated component, or the components may be integrated in various other combinations (e.g. components 120 and 122 may be implemented as an integrated component, or components 120 and 124 may be implemented as an integrated component, or components 122 and 124 may be implemented as an integrated component, etc.). These and other implementations are within the scope of the present invention.

In one embodiment, the main student interface component 120 is the component that interfaces with a student to make much of the server's functionality available to the student. For example, through component 120, a student may access his/her student account to view grades, register for courses, pay for courses, view class schedules, etc. Component 120 may also enable a student to actually take a course online. For example, component 120 may enable a student to access and study online courses materials, take online tests, etc. In addition to these functionalities, component 120 may also provide some functionalities that facilitate the discussion of issues pertaining to the subject matter taught by a course. In particular, in one embodiment, it is component 120 that causes information to be presented to a student that includes content (or references to the content) pertaining to the subject matter taught by a course. It is also component 120 that enables a student to post a set of content (or a reference to a set of content) to a discussion forum to initiate discussion of the set of the set of content. These and other functionalities may be provided by component 120. The operation of component 120, in accordance with one embodiment of the present invention, will be described in more detail in a later section.

In performing its function of causing information to be presented to a student that includes content pertaining to the subject matter taught by a course, the main student interface component 120 may invoke the aid of the CSE component 124. In one embodiment, it is the CSE 124 that determines what subject matter is taught by a course, and it is the CSE 124 that causes a search to be performed to find one or more sets of content that pertains to the subject matter taught by the course. In one embodiment, the CSE 124 causes the search to be performed by generating and providing one or more search queries to a search engine 126. It is then up to the search engine 126 to search the online resources 108 to find content that pertains to the subject matter taught by a course. It should be noted that, for purposes of the present invention, CSE 124 is not required to include a search engine 126. Rather, if so desired, CSE 124 may provide its one or more search queries to a search engine that is available online (e.g. Google, Bing, etc.), and have that search engine perform the one or more searches to find content that pertains to the subject matter taught by a course. In either case, the CSE 124 receives the results of the search. The CSE 124 then provides the results to the main student interface component 120 to be presented to the student. The operation of CSE 124, in accordance with one embodiment of the present invention, will be described in greater detail in a later section.

In enabling a student to post a set of content (or a reference to a set of content) to a discussion forum to initiate discussion of the set of content, the main student interface component 120 may interact with the discussion forum component 122. In particular, the main student interface component 120 may instruct the discussion forum component 122 to post a set of content (or a reference to a set of content) to a certain area or section of the discussion forum and to start a new discussion. Thereafter, further discussion of the set of content is carried out through the discussion forum component 122. In one embodiment, the discussion forum component 122 allows students to review sets of content that have been posted or referenced, review comments that have been posted in a discussion, post new comments in a discussion, etc. The operation of the discussion forum component 122, in accordance with one embodiment of the present invention, will be described in more detail in a later section.

In performing their functions, components 120, 122, and 124 may likely need access to various sets of information. In one embodiment, these sets of information are maintained in repository 130, and may include student profile information, enrollment information, course information, content rating information, etc. The student profile information includes information specific to each student, such as name, student ID, address, degree plan or course of study, etc. In one embodiment, the profile information for a student also includes personal aspects of the student. For example, the personal aspects may indicate that the student is interested in certain topics (e.g. sports, cooking, etc.), certain people (e.g. athletes, actors, business professionals, etc.), certain locations (e.g. cities, states, national parks, etc.), certain business entities (e.g. companies, sports teams, etc.), certain educational institutions (e.g. high schools, colleges/universities, etc.), etc. As will be elaborated upon in a later section, these personal aspects may be taken into account in filtering or ranking the content that is found to pertain to the subject matter taught by a course.

The enrollment information indicates which students are taking or have taken each course. The enrollment information may also indicate which courses are being audited by which student, and even more generally, which student is interested in (but has not necessarily taken or audited) which course. This information can be used to determine, for a particular student, which course or courses are associated with that student.

The course information includes information specific to each course. For example, the course information for a course may include the course materials and tests for that course. In addition, the course information for a course may include information indicating the subject matter taught by that course. As used herein, the term subject matter refers broadly to anything taught by a course, including but not limited to concepts, skills, topics, themes, course objectives, know-how, etc. The subject matter taught by a course may be expressed, for example, as one or more sets of terms. For example, for an economics course, the sets of terms may include “money supply”, “supply and demand”, “inflation”, “graphing” (e.g. pertaining to the skill of graphing supply and demand curves), etc. These sets of terms may be included in a search query to find content that pertains to the subject matter taught by a course. In one embodiment, the subject matter taught by a course, and hence, the sets of terms associated with a course, may change over time (e.g. throughout the term of a course). For example, a course may have weekly course objectives. For a certain week, the objective of the course may be to teach the concept of “money supply”, while for another week, the objective may be to teach the concept of “supply and demand”. As the sets of terms change over time, the sets of content that are found to pertain to the subject matter taught by a course may change.

The content rating information includes information that indicates the ratings that students have given to each set of content found to pertain to the subject matter taught by a course. This rating information can be used for various purposes. For example, if a set of content relevant to the subject matter taught by a particular course receives high ratings from numerous students, then that set of content might be incorporated into the curriculum of the particular course.

The repository 130 may store and maintain the above sets of information as well as other sets of information. For the sake of simplicity, it is assumed herein that all of the various sets of information are maintained in a single repository. This is not required, however. If so desired, the different sets of information may be maintained in separate repositories in any desired combination. Also, for purposes of the present invention, the information in the repository 130 may be stored in any form using any type of data structure. For example, the information may be stored in one or more files, in one or more tables, as comma separated values, as linked lists, in a flat database, in a hierarchical database, in a relational database, or in any other type of format or data structure. If the information is stored in a database, such as a relational database, the repository 130 may include a database manager (not shown) that receives and processes queries to find, update, and extract information from the repository 130. All such embodiments of the repository 130 are within the scope of the present invention.

### Sample Operation

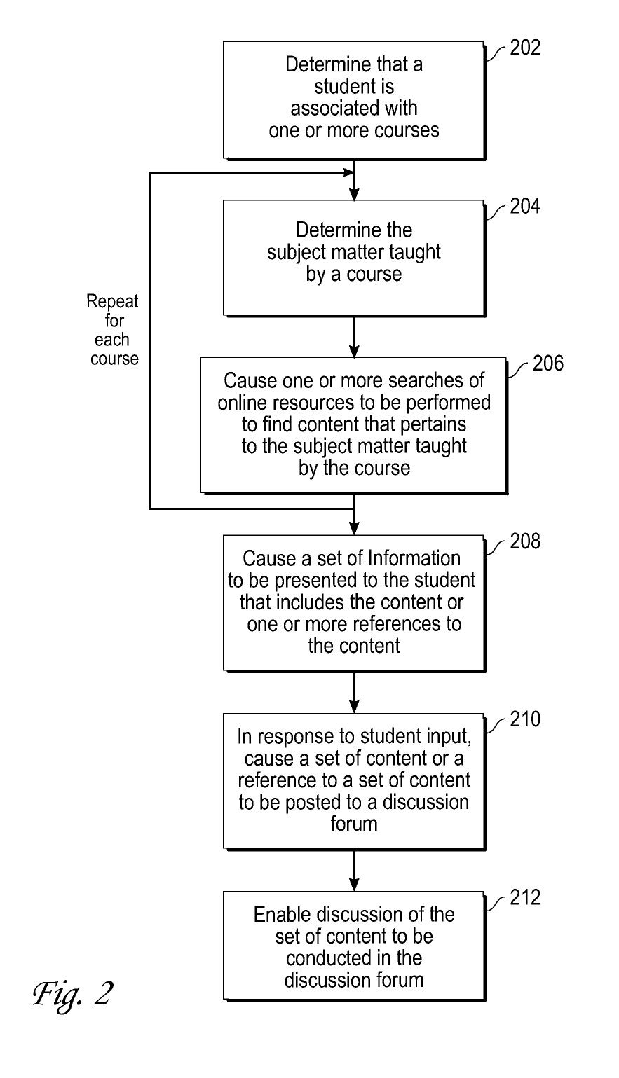

With the above sample system 100 in mind, a sample operation in accordance with one embodiment of the present invention will now be described with reference to the flow diagram shown in FIG. 2 and the system diagram shown in FIG. 1.

Initially, a student may use a user device 106 to interact with the main student interface component 120 to log in to the server 102. After authenticating the student, the main student interface component 120 may generate a customized home page for the student that includes information specific to that student. This home page may include content (or references to content) that pertains to the subject matter taught by one or more courses with which the student is associated. To determine this content, the main student interface component 120 may invoke the CSE 124. To do so, the main student interface component 120 may access the repository 130 to obtain the profile information for the student, extract the student's ID therefrom, and invoke the CSE 124 (as part of the invocation, the main student interface component 120 passes the student's ID to the CSE 124).

In response to the invocation, the CSE 124 may access the enrollment information stored in repository 130. Based on the enrollment information and the student's ID, the CSE 124 may determine (block 202 of FIG. 2) which course or courses the student is associated with. In one embodiment, a student is associated with a course if the student is currently taking or enrolled in that course. Alternatively, a student may be associated with a course if the student is taking, has taken, is auditing, or is interested in that course. For the sake of simplicity, it will be assumed in the following example that the student is associated with only one course. However, it should be noted that a student may be associated with any number of courses. From the enrollment information, the CSE 124 may obtain the course ID for the course with which the student is associated.

The CSE 124 may then access the course information stored in repository 130. Based on the course information and the course ID, the CSE 124 may obtain the course information specific to the course with which the student is associated. From this course information, the CSE 124 may determine (block 204 of FIG. 2) the subject matter that is taught by the course. For example, the course information may include one or more sets of terms that specify what is taught by the course. The one or more sets of terms may represent the subject matter that is taught by the course, and may be obtained by the CSE 124.

Armed with the subject matter taught by the course, the CSE 124 may proceed to cause (block 206 of FIG. 2) one or more searches of the online resources 108 to be performed to find one or more sets of content that pertain to the subject matter taught by the course. To do so, the CSE 124 may generate one or more search queries, and provide them to the search engine 126 or another search engine (e.g. Google, Bing, etc.) that is available online. In generating the one or more search queries, the CSE 124 may use the one or more sets of terms individually or in combination. For example, the CSE 124 may generate a single search query that includes all of the sets of terms that specify the subject matter taught by the course, or it may generate multiple search queries with each search query having just one of the sets of terms, or it may generate multiple search queries with each search query having a subset of the sets of terms, etc. All such queries are within the scope of the present invention.

In generating the one or more search queries, the CSE 124 may include one or more personal aspects of the student in the search queries to further tailor the search to the student. To do so, the CSE 124 may use the student's ID to access the student's profile information stored in repository 130. As noted previously, a student's profile information may include information that indicates one or more personal aspects of the student. These personal aspects may indicate, for example, that the student is interested in certain topics (e.g. sports, cooking, etc.), certain people (e.g. athletes, actors, business professionals, etc.), certain locations (e.g. cities, states, national parks, etc.), certain business entities (e.g. companies, sports teams, etc.), certain educational institutions (e.g. high schools, colleges/universities, etc.), etc. The CSE 124 may obtain these personal aspects from the profile information, and may include one or more search terms that reflect one or more of these personal aspects in one or more of the search queries that the CSE 124 generates. Thus, a search query generated by the CSE 124 may include one or more (perhaps all) of the sets of terms that specify the subject matter taught by the course, as well as one or more search terms that reflect one or more (perhaps all) of the personal aspects of the student. In such a search query, the CSE 124 may indicate that the one or more sets of terms that specify the subject matter taught by the course are primary search terms, and that the one or more search terms that reflect one or more of the personal aspects of the student are secondary search terms.

Based on the one or more search queries generated and provided by the CSE 124, the search engine 126 (or another search engine that is available online) performs one or more searches of the online resources 108 to find one or more sets of content that pertain to at least a portion of the subject matter taught by the course (and, perhaps, that are relevant to the student). The results of the search may be ranked, for example, based upon how many search terms appear in each set of content, whether the search terms that do appear are primary or secondary search terms, etc. The search results are provided to the CSE 124. These search results represent the one or more sets of content that pertain to at least a portion of the subject matter taught by the course associated with the student. In the current example, only one course is associated with the student. If multiple course are associated with the student, then operations 204 and 206 may be repeated for each associated course.

After obtaining the search results, the CSE 124 may provide the results to the main student interface component 120. If a set of content is relatively small, the CSE 124 may provide the actual set of content to component 120. Otherwise, the CSE 124 may provide just a reference (e.g. a link) to the set of content.

Armed with the search results, the main student interface component 120 may proceed to cause (block 208 of FIG. 2) a set of information to be presented to the student that includes the one or more sets of content (or references thereto) that pertain to the course or courses associated with the student. To do so, the main student interface component 120 may incorporate the one or more sets of content (or one or more references to the one or more sets of content) from the search results into the customized home page that is generated for the student. This customized home page may include one or more control elements that enable the student to rate each set of content, and one or more control elements that enable the student to post one or more sets of content (or references thereto) to a discussion forum. This home page is provided to the user device 106 that is used by the student, and is rendered by that user device 106 to the student.

Thereafter, using the user device 106, the student may review the one or more sets of content. Using the control elements, the student may provide a rating for one or more of the sets of content with regard to the course with which the student is associated. If such a rating is provided by the student for a set of content, that rating is received by the main student interface component 120, and stored within repository 130. The rating may be stored such that it is associated with the set of content and with the course that is associated with the student (note: a set of content may pertain to the subject matter taught by multiple courses; thus, a set of content may have one rating with regard to one course and another rating with regard to another course). In addition, based upon the rating provided by the student and other ratings provided by other students (e.g. other students taking the same course), the main student interface component 120 may derive an overall rating for the set of content with regard to the course with which the student is associated. This overall rating may also be stored in the repository 130 in association with the set of content and the course that is associated with the student. This overall rating may be used for various purposes. For example, if the rating for the set of content is sufficiently high, and a sufficiently large number of students rated it highly, then that set of content may be incorporated into the curriculum of the course with which the student is associated.

In addition to reviewing and rating the one or more sets of content, the student may also wish to initiate a discussion of one of the sets of content. To do so, the student may invoke one of the control elements on the home page to post a set of content (or a reference to the set of content) to a discussion forum to start a discussion of that set of content. As part of initiating the discussion, the student may specify the section of the discussion forum in which the set of content is to be posted. For example, the student may specify that the set of content is to be posted to the general “business” section of the discussion forum. Alternatively, the student may post the set of content to a more specify section of the discussion forum, such as one having to do specifically with “economics”, or one that is specific to the course with which the student is associated. In one embodiment, the discussion forum may have many different sections having many different levels of granularity. The set of content may be posted to any desired discussion forum section at any desired granularity level. Upon receiving input from the student to post a set of content (or a reference to a set of content) to a certain section of a discussion forum, the main student interface component 120 may respond by causing (block 210 of FIG. 2) that set of content (or a reference to that set of content) to be posted to the certain section of the discussion forum. The main student interface component 120 may do so by invoking the discussion forum component 122. As part of the invocation, the main student interface component 120 may provide to the discussion forum component 122 the set of content to be posted (or a reference to the set of content), and an indication of the certain section of the discussion forum in which the set of content is to be posted. In response, the discussion forum component 122 may post the set of content (or a reference to the set of content) to the certain section of the discussion forum, and start a discussion of the set of content.

Thereafter, the discussion forum component 122 may enable (block 212 of FIG. 2) the set of content to be discussed within the certain section of the discussion forum. For example, the discussion forum component 122 may enable the student, via the user device 106, to provide one or more comments on the set of content. These comments are posted by the discussion forum component 122 to the certain section of the discussion forum. The discussion forum component 122 may also allow other students to review the set of content and the student's comments on the set of content, and provide comments of their own. These comments are likewise posted by the discussion forum component 122 to the certain section of the discussion forum. The student or other students may then provide comments in response to the comments provided by other students, and the student or other students may provide comments in response to those responses, and so forth. All such comments may be posted by the discussion forum component 122 to the certain section of the discussion forum. By doing so, the discussion forum component 122 enables and facilitates discussion of the set of content, which in turn fosters the constructive and focused discussion of issues pertaining to the subject matter taught by the course with which the student is associated.

### Modifications/Variations

In the sample operation described above, the search for the content pertaining to the subject matter taught by a course is conducted at the time a student accesses his/her account and the customized home page is generated. This need not be the case. If so desired, the search for content pertaining to the subject matter taught by a course associated with a student may be performed beforehand and the results may be stored. When it comes time to generate the customized home page for the student, the stored search results may be used to populate the home page.

Also, in the above sample operation, the main student interface component 120 receives the input from the student to initiate a discussion of a set of content, and responds by invoking the discussion forum component 122. As an alternative, the control elements on the customized home page may invoke the discussion forum component 122 directly rather than going through the main student interface component 120.

These and other variations/modifications are within the scope of the present invention.

### Hardware Overview

With reference to FIG. 3, there is shown a block diagram of a computer system that may be used to implement at least a portion of the present invention. Computer system 300 includes a bus 302 or other communication mechanism for communicating information, and one or more hardware processors 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques and components (e.g. main student interface component 120, discussion forum component 122, CSE 124, etc.) described herein using customized hard-wired logic, one or more ASICs or FPGAs, firmware and/or program logic which in combination with the computer system causes or programs computer system 300 to be a special-purpose machine. According to one embodiment, the techniques disclosed herein for components 120, 122, and 124 are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage device 310, or other non-volatile storage for later execution.

At this point, it should be noted that although the invention has been described with reference to specific embodiments, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the issued claims.

What is claimed is:

1. A method, comprising:
determining that a particular student is associated with a particular educational course;
determining subject matter taught by the particular educational course;
causing a search of online resources to be performed to find one or more sets of content that pertain to at least a portion of the subject matter taught by the particular educational course; and
causing a set of information to be presented to the particular student, wherein the information includes the one or more sets of content or one or more references to the one or more sets of content;
wherein the method is performed by one or more computer systems.

2. The method of claim 1, wherein determining the subject matter taught by the particular educational course comprises:
accessing course information that contains information pertaining to a plurality of educational courses; and
obtaining from the course information one or more sets of terms that specify the subject matter taught by the particular educational course.

3. The method of claim 2, wherein causing the search of online resources to be performed comprises:
generating a search query that includes at least one of the one or more sets of terms that specify the subject matter taught by the particular educational course.

4. The method of claim 2, wherein causing the search of online resources to be performed comprises:
obtaining from a set of profile information for the particular student information that includes one or more personal aspects of the particular student; and
generating a search query that includes at least one of the one or more sets of terms that specify the subject matter taught by the particular educational course and at least one of the one or more personal aspects of the particular student.

5. The method of claim 1, wherein determining that the particular student is associated with the particular educational course comprises:
accessing enrollment information that indicates which course or courses the particular student is currently taking; and
determining, based at least in part upon the enrollment information, that the particular student is currently taking the particular course.

6. The method of claim 1, wherein the subject matter taught by the particular course includes one or more course objectives that changes throughout a term of the particular course.

7. The method of claim 1, wherein the one or more sets of content includes a particular set of content, and wherein the method further comprises:
in response to input from the particular student, causing the particular set of content or a reference to the particular set of content to be posted to a particular section of a discussion forum;
receiving a comment from the particular student pertaining to the particular set of content;
causing the comment from the particular student to be posted to the particular section of the discussion forum in association with the particular set of content;
receiving comments from one or more other students pertaining to the particular set of content; and
causing the comments from the one or more other students to be posted to the particular section of the discussion forum in association with the particular set of content.

8. The method of claim 1, wherein the one or more sets of content includes a particular set of content, and wherein the method further comprises:
receiving from the particular student a rating for the particular set of content with regard to the particular educational course;
based at least in part upon the rating received from the particular student and one or more ratings received from one or more other students, deriving an overall rating for the particular set of content with regard to the particular educational course; and
storing the overall rating in association with the particular set of content and the particular educational course.

9. A system comprising one or more computer systems, wherein the one or more computer systems are configured to perform operations comprising:
determining that a particular student is associated with a particular educational course;
determining subject matter taught by the particular educational course;
causing a search of online resources to be performed to find one or more sets of content that pertain to at least a portion of the subject matter taught by the particular educational course; and
causing a set of information to be presented to the particular student, wherein the information includes the one or more sets of content or one or more references to the one or more sets of content.

10. The system of claim 9, wherein determining the subject matter taught by the particular educational course comprises:
accessing course information that contains information pertaining to a plurality of educational courses; and
obtaining from the course information one or more sets of terms that specify the subject matter taught by the particular educational course.

11. The system of claim 10, wherein causing the search of online resources to be performed comprises:
generating a search query that includes at least one of the one or more sets of terms that specify the subject matter taught by the particular educational course.

12. The system of claim 10, wherein causing the search of online resources to be performed comprises:
obtaining from a set of profile information for the particular student information that includes one or more personal aspects of the particular student; and
generating a search query that includes at least one of the one or more sets of terms that specify the subject matter taught by the particular educational course and at least one of the one or more personal aspects of the particular student.

13. The system of claim 9, wherein determining that the particular student is associated with the particular educational course comprises:
accessing enrollment information that indicates which course or courses the particular student is currently taking; and
determining, based at least in part upon the enrollment information, that the particular student is currently taking the particular course.

14. The system of claim 9, wherein the subject matter taught by the particular course includes one or more course objectives that changes throughout a term of the particular course.

15. The system of claim 9, wherein the one or more sets of content includes a particular set of content, and wherein the one or more computer systems are configured to perform further operations comprises:
in response to input from the particular student, causing the particular set of content or a reference to the particular set of content to be posted to a particular section of a discussion forum;
receiving a comment from the particular student pertaining to the particular set of content;
causing the comment from the particular student to be posted to the particular section of the discussion forum in association with the particular set of content;
receiving comments from one or more other students pertaining to the particular set of content; and
causing the comments from the one or more other students to be posted to the particular section of the discussion forum in association with the particular set of content.

16. The system of claim 9, wherein the one or more sets of content includes a particular set of content, and wherein the one or more computer systems are configured to perform further operations comprises:
receiving from the particular student a rating for the particular set of content with regard to the particular educational course;
based at least in part upon the rating received from the particular student and one or more ratings received from one or more other students, deriving an overall rating for the particular set of content with regard to the particular educational course; and
storing the overall rating in association with the particular set of content and the particular educational course.

17. A computer readable storage medium storing instructions which, when executed by one or more processors, cause the one or more processors to perform operations comprising:
determining that a particular student is associated with a particular educational course;
determining subject matter taught by the particular educational course;
causing a search of online resources to be performed to find one or more sets of content that pertain to at least a portion of the subject matter taught by the particular educational course; and
causing a set of information to be presented to the particular student, wherein the information includes the one or more sets of content or one or more references to the one or more sets of content.

18. The computer readable storage medium of claim 17, wherein determining the subject matter taught by the particular educational course comprises:
accessing course information that contains information pertaining to a plurality of educational courses; and
obtaining from the course information one or more sets of terms that specify the subject matter taught by the particular educational course.

19. The computer readable storage medium of claim 18, wherein causing the search of online resources to be performed comprises:
generating a search query that includes at least one of the one or more sets of terms that specify the subject matter taught by the particular educational course.

20. The computer readable storage medium of claim 18, wherein causing the search of online resources to be performed comprises:
obtaining from a set of profile information for the particular student information that includes one or more personal aspects of the particular student; and
generating a search query that includes at least one of the one or more sets of terms that specify the subject matter taught by the particular educational course and at least one of the one or more personal aspects of the particular student.

21. The computer readable storage medium of claim 17, wherein the one or more sets of content includes a particular set of content, and wherein the instructions cause the one or more processors to perform further operations comprising:
in response to input from the particular student, causing the particular set of content or a reference to the particular set of content to be posted to a particular section of a discussion forum;
receiving a comment from the particular student pertaining to the particular set of content;
causing the comment from the particular student to be posted to the particular section of the discussion forum in association with the particular set of content;
receiving comments from one or more other students pertaining to the particular set of content; and
causing the comments from the one or more other students to be posted to the particular section of the discussion forum in association with the particular set of content.
